(19) United States
(12) Patent Application Publication
(10) Pub. No.: US 2025/0161904 A1
(43) Pub. Date: May 22, 2025

(54) HYDROGEL-BASED REGENERATIVE ADSORBENTS

(71) Applicants: Elham Fini, Phoenix, AZ (US); Albert Hung, Tempe, AZ (US)

(72) Inventors: Elham Fini, Phoenix, AZ (US); Albert Hung, Tempe, AZ (US)

(21) Appl. No.: 18/954,207

(22) Filed: Nov. 20, 2024

Related U.S. Application Data
(60) Provisional application No. 63/600,978, filed on Nov. 20, 2023.

(51) Int. Cl. B01J 20/20; B01J 20/28

(52) U.S. Cl. CPC B01J 20/20; B01J 20/28009; B01J 20/28011; B01J 2220/4887

(57) ABSTRACT

Adsorbents for microbial remediation of air within a built environment can be used remove volatile organic compounds (VOCs) and improve indoor air quality. The adsorbents include gas-permeable polysaccharide hydrogels containing biochar and bacteria that degrade VOCs to less toxic compounds.

### CROSS-REFERENCE TO RELATED APPLICATION

This application claims the benefit of U.S. Patent Application No. 63/600,978 filed on Nov. 20, 2023, which is incorporated herein by reference in its entirety.

### STATEMENT OF GOVERNMENT SUPPORT

This invention was made with government support under 1935723 awarded by the National Science Foundation. The government has certain rights in the invention.

### TECHNICAL FIELD

This invention relates to hydrogel-based regenerative adsorbents that include iron-rich biochar and bacteria, as well as use of the adsorbents to remediate air.

### BACKGROUND

Adsorbents that have sufficient reaction kinetics are typically engineered materials and can be too expensive to use for a single pass. In-situ regeneration can be used to avoid discarding or downcycling sorbents. Adsorbent regeneration can be accomplished through heating, decreasing the pressure, or exposing the surface to a change in pH or other fluid. These are energy-intensive processes that can contribute to even more emissions or environmental pollution or contamination.

### SUMMARY

This disclosure describes adsorbents for microbial remediation of air within a built environment to remove volatile organic compounds (VOCs) and improve indoor air quality. The adsorbents use gas-permeable polysaccharide hydrogels containing biochar and bacteria that degrade VOCs to less toxic compounds.

In a first general aspect, an adsorbent includes a hydrogel comprising polysaccharide. The adsorbent also includes bacteria in the hydrogel. The adsorbent also includes biochar, graphite, or both in the hydrogel. The adsorbent is regenerative.

Implementations may include one or more of the following features. The hydrogel can be amphiphilic. The polysaccharide can include include alginate, chitosan, or a combination thereof. The alginate can be treated with a metal salt. The biochar, the graphite, or both may include one or more of iron, copper, phosphorus, sulfur, an oxide thereof, or any combination thereof. The bacteria may include one or more microbes that metabolize volatile organic compounds (e.g., Pseudomonas, Rhodococcus, Enterobacter sp., or any combination thereof). In some cases, the bacteria include one or more sulfur-oxidizing microbes (e.g., Gordonia, Nocardia, or a combination thereof).

The adsorbent can be in the in the form of a bead. In some cases, the adsorbent includes a surfactant. In certain cases, the adsorbent includes cyclodextrin. In certain cases, the adsorbent includes a quaternary ammonium compound. In certain cases, the adsorbent includes a vinyl monomer under photoinduced electron transfer-reversible addition-fragmentation chain transfer polymerization.

In a second general aspect, removing volatile organic compounds (e.g., polycyclic aromatic hydrocarbons) from the air within a building includes contacting air within the building with the adsorbent of the first general aspect.

Implementations of the second general aspect may include one or more of the following features. The adsorbent can be incorporated within one or more construction materials of the building or within an air handling system of the building. In some cases, the adsorbent is incorporated within one or more mobile units configured to be in fluid communication with an interior of the building.

The details of one or more embodiments of the subject matter of this disclosure are set forth in the accompanying drawings and the description. Other features, aspects, and advantages of the subject matter will become apparent from the description, the drawings, and the claims.

### DETAILED DESCRIPTION

This disclosure describes gas-permeable polysaccharide hydrogel-based regenerative adsorbents containing biochar and bacteria. In one example, the gas-permeable polysaccharide hydrogel is an amphiphilic sodium-alginate hydrogel encapsulating an iron-rich biochar made from microalgae and inoculated with bacteria that can degrade target volatile organic compounds (VOCs). The hydrogels can be incorporated in air-purification systems or in conjunction with particle-removal filters for remediation of air (e.g., indoor air) that contains pollutants (e.g., VOCs). Suitable air-purification systems and particle-removal filters include high-efficiency particulate air (HEPA) filters and minimum efficiency reporting value (MERV) filters, respectively.

This disclosure describes the incorporation of select bacteria in biochar (e.g., from microalgae), and use of the resulting biochar in a hydrogel-based adsorbent. The bacteria advantageously exhibit syntrophic interactions, in which each species specializes in degrading different components of contaminants and their by-products. For example, Rhodococcus is particularly effective at breaking down benzo[a]pyrene, while Pseudomonas excels in degrading formaldehyde. Additionally, Enterobacter demonstrates a strong capability in degrading xylene. These bacteria metabolize VOCs through enzymatic pathways that convert intricate hydrocarbon structures into simpler, less harmful compounds. The microbiome's capabilities are further enhanced through iron-assisted electron shuttling facilitated by iron-rich biochar.

One example of a suitable hydrogel-based adsorbent is an amphiphilic sodium-alginate hydrogel encapsulating an iron-rich carbonaceous adsorbent made from micro-algae and inoculated with microbiomes. Iron can mediate electron transfer through redox reactions without the need for external electrical input, particularly in the presence of a selected bacterial community that utilizes iron as an electron acceptor, thereby facilitating the degradation of volatile organic compounds (VOCs). Preparation of the amphiphilic sodium-alginate hydrogel includes treatment with a metal salt (e.g., CaCl₂)) to crosslink the carboxylic acid groups of polymers with multivalent cations to form a gel. Under acidic conditions, the hydrogen-bond interaction between the carboxyl groups of sodium-alginate molecules is enhanced, causing the molecular chain to shrink. When the pH of the hydrogel increases, the hydrophilicity of sodium alginate increases, and the molecular chain extends. Iron-rich carbon from microalgae has the ability to facilitate catalytic degradation of benzothiophene. When the biochar and the hydrogel-based adsorbent are combined, the resulting adsorbent facilitates a regenerative VOC-degradation mechanism for a mixture of VOCs with known toxicity (e.g., benzo[a]pyrene and benzothiophene) that are constituents of emissions from various components of the built environment (e.g., asphalt-surfaced areas).

The hydrogels described herein are based on polysaccharides (e.g., alginate, chitosan) that are relatively abundant and biodegradable. For the purpose of remediating air, these hydrogels can be formed into small beads, modified to be partially amphiphilic, and used to promote the absorption and diffusion of non-polar hydrocarbons. In some examples, the outer surface of the beads can be modified to promote mechanical strength, limit water loss, and hinder external microbial growth or fouling.

Amphiphilic hydrogels are advantageous at least in part because the inclusion of hydrophobic units can improve mechanical properties, adhesion, and encapsulation of non-polar components in self-assembled hydrophobic blocks or micelles. The hydrophobic units may be physically incorporated (less expensive but less stable) or covalently grafted to the alginate. One example of amphiphilic modification of a hydrogel is mixing with a surfactant such as sodium dodecyl sulfate (SDS) or Brij® 35. A non-ionic surfactant can soften the hydrogel, whereas an anionic surfactant such as SDS typically stiffens it (e.g., based at least in part on increased electrostatic repulsion). Another acceptable modifier is cyclodextrin (CD), an oligosaccharide ring with a hydrophobic pocket that can capture non-polar molecules. The same cross-linking agents used for stabilizing polysaccharide hydrogels can also immobilize CD on the hydrogel.

In some examples, the molecular-scale hydrophobic pockets of SDS or CD are too small for efficient diffusion of VOCs. In these examples, more-intensive modification of alginate with polymer brushes via photoinduced electron transfer-reversible addition-fragmentation chain transfer (PET-RAFT) polymerization can be incorporated. PET-RAFT is appealing as a green and atom-economical strategy for controlled radical polymerization. The alginate grafted with hydrophobic polymethacrylate (PMA) brushes, upon hydrogel formation, can self-assemble PMA blocks of sizes commensurate with the length of the brush. The hydrophobic brush can also passivate the air surface of the hydrogel to reduce surface energy; a hydrophobic passivating layer at the surface can improve water retention.

In some examples, more-intensive surface modification of the hydrogel beads can be carried out to promote durability and service life. Chitosan is a cationic polysaccharide with antimicrobial properties that can be used to coat the surface of alginate hydrogels. Strong electrostatic attraction between chitosan and alginate can lead to densification of the surface and increased hydrophobicity due to charge neutralization. Surface shells that are even thicker can be formed from layer-by-layer electrostatic assembly of alternating layers of chitosan and alginate. Quaternary ammonium compounds or surfactants can be incorporated into the assembled shell to promote antimicrobial activity or hydrophobicity. When the chitosan is prepared in a carbonic acid solution, calcium carbonate can mineralize in the shell from the calcium in the alginate gel. The resulting porous mineral layer can help retain water and maintain structural stability while allowing for gaseous diffusion.

Sulfur-oxidizing microbes (e.g., Gordonia and Nocardia) can devulcanize sulfur-crosslinked rubber. Since some toxic VOCs such as benzothiophene include sulfur in their thiophene ring (C₄H₄S), these sulfur-oxidizing microbes can be incorporated separately and in conjunction with Enterobacter sp. The use of colony-forming units (CFUs) of extracted and diluted samples of bacteria in each scenario can be evaluated following exposure to various VOCs. Synergy between bacteria and iron-rich biochar can increase the efficacy of adsorbent regeneration with iron-facilitated electron shuttling. Accordingly, in some examples, the bacteria are housed in the iron-rich biochar.

The presence of nitrogen-coordinated iron (Fe) in iron-rich biochar developed from algae results in significant enhancement of its catalytic activity, initiating the degradation process of certain VOCs, including hexanethiol and dibenzothiophene. Notably, this capability is absent on biochar surfaces without any coordinated metal. Dibenzothiophene and hexanethiol are degraded at active sites containing nitrogen-coordinated Fe that are respectively associated with the aromatic cleavage of the thiophene ring and the separation of the hexane-thiol SH group. Fe-biochar active zones effectively degrade hexanethiol to SH+C₆H₁₃ components. This organic compound is not decomposed on any biochar active zones containing just nitrogen in the absence of Fe. This further supports the role of Fe in Fe-biochar in removing pollutants through their degradation, besides the role of Fe in sorption. Furthermore, certain metals such as copper or iron increase the amount of benzothiophene absorbed. Incorporation of heteroatoms such as phosphorus or sulfur can also be beneficial, not only because of their specific interactions but also because of their capability to introduce defects and catalytic centers active in visible light, leading to the photooxidation of benzothiophene. In some examples, the initial degradation of VOCs can be complemented and/or amplified by the presence of bacteria, resulting in a more comprehensive and/or faster breakdown of VOCs. Examples of VOCs include polycyclic aromatic hydrocarbons (PAHs), such as benzo[a]pyrene and benzothiophene.

Biochar obtained from microalgae cultivated in wastewater and biochar made from animal waste are rich in iron oxides. Moreover, in the biochar matrix, heteroatoms such as sulfur or phosphorus are present as intrinsic components of the biomass. Biochar also has very small pores that are similar in size to the benzothiophene molecule and can absorb these species. Another carbonaceous carrier is the fine-tuned porous 3D structure of graphite, which provides a high surface area with accessible pores for adsorption while the specific functional groups enhance selectivity. Environmental factors such as temperature, pH, and pressure further influence the equilibrium and kinetics of the process, leading to a multifaceted interaction between functionalized graphite and VOCs. Inoculating a carbonaceous carrier (iron-rich biochar or graphite) with bacteria can enhance the degradation properties, while housing the latter carrier in hydrogel provides protection for the microbiome and facilitates in-situ degradation.

The synergy between iron-rich carbon and phenolics in the biochar can be enhanced using density functional theory (DFT) and machine learning to engineer an algae-derived biochar with a high affinity for specific VOCs such as dibenzothiophene. Biochar inoculated with VOC-degrading microbiomes and can be encapsulated in a hydrogel to promote microbial survival and ensure the residence time necessary for effective degradation of VOCs. The high affinity and electron-shuttling properties of the biochar, combined with the extended residence time provided by the hydrogel, can be optimized to facilitate the regeneration of the adsorbent.

The synergy between bacteria and iron-rich biochar enhances the efficiency of electron shuttling. In this interaction, bacteria catalyze redox reactions, while the iron-rich biochar offers a conducive physical and chemical environment that facilitates these processes. Specific bacterial communities are selected based on their roles in biogeochemical cycles and their ability to mediate electron transfer between organic substrates and iron.

Preparation of a pH-sensitive sodium-alginate hydrogel can be achieved by using metal salts (e.g., CaCl₂)) to crosslink the carboxylic acid groups of polymers with multivalent cations to form a gel. Under acidic conditions, the hydrogen-bond interaction between the carboxyl groups of sodium-alginate molecules is enhanced, causing the molecular chain to shrink. When the pH value increases, the hydrophilicity of sodium alginate also increases, and the molecular chain extends. Biochar inoculated with a select microbiome is encapsulated in the hydrogel to facilitate a regenerative VOC-degradation mechanism specifically for a mixture of VOCs with known toxicity (including but not limited to dibenzothiophene, benzothiazole, and benzo[a]pyrene).

Degradation efficacy of the sulfur-oxidizing microbes (e.g., Gordonia) is assessed separately and in conjunction with a selected microbiome (e.g., Pseudomonas, Rhodococcus, and Enterobacter sp., which can be acquired from the American Type Culture Collection). Colony-forming units (CFUs) of extracted and diluted samples are used to evaluate the survival rate of microbiomes in each scenario when exposed to various VOCs. VOC metabolism in the above microbiomes is also assessed to underscore the synergy between the iron-rich adsorbent and the microbiome to enhance adsorption and regeneration through iron-mediated electron shuttling.

The presence of —N—Fe coordination in iron-rich biochar from algae is understood to enhance the biochar's catalytic activity, initiating the degradation process of certain VOCs, including hexanethiol and dibenzothiophene. Notably, this unique capability is absent on biochar surfaces that do not have a coordinated metal. Dibenzothiophene and hexanethiol are degraded at the N—Fe active sites that are respectively associated with the aromatic cleavage of the thiophene ring and the separation of the hexanethiol SH group.

Fe-biochar active zones effectively degrade hexane-thiol to SH+C₆H₁₃ components. This organic compound is not typically decomposed on any biochar active zones containing just N in the absence of Fe. This further supports the role of Fe in Fe-biochar in removing pollutants through their degradation, besides the role of Fe in sorption. The initial steps of degradation of VOCs observed using DFT are the preliminary steps of degradation; these could be complemented and/or amplified by the presence of microbiomes, resulting in a more comprehensive and/or faster breakdown of VOCs.

To engineer a regenerative hydrogel-based adsorbent, an iron-rich biochar derived from micro-algae (e.g., cultivated in wastewater) is encapsulated in hydrogel. Iron-rich biochar is produced by hydrothermal liquefaction of algal biomass. Processing parameters (temperature, heating rate, and residence time) are tailored to produce biochar with a high level of phenolic functional groups, for enhanced affinity toward select VOCs. Lower processing temperatures, slower heating rates, and shorter residence times tend to favor the formation and retention of functional groups in biochar. The adsorbents will enhance CO₂ sequestration by converting algal biomass cultivated and harvested from wastewater into biochar, creating highly efficient carbonaceous adsorbents.

To further enhance the performance of the adsorbent, the iron-rich biochar is inoculated with VOC-degrading microbiomes (e.g., Pseudomonas, Rhodococcus, and Enterobacter species) that have high resilience and can adapt to a variety of environmental conditions, including an acidic environment. The Pseudomonas and Enterobacter species have robust electron-shuttling systems. The inoculation can be carried out shortly after biochar production, while the biochar is still warm but not at temperatures harmful to the bacteria. A bacterial suspension can be applied to the biochar surface during this cooling phase, promoting the rapid colonization of the porous biochar by the bacteria. Residual heat aids in biofilm formation, which enhances the biochar's capacity for biodegradation of VOCs.

Inoculated biochar is incorporated into sodium alginate hydrogel. The biochar acts as a supportive habitat for the microbiome, promoting microbial survival while providing the essential residence time needed for effective degradation of VOCs. This dual functionality enhances the biochar's capacity to both capture and decompose VOCs, significantly improving its overall effectiveness as an adsorbent.

The hydrogels are made from polysaccharides, such as alginate and chitosan, which are abundant and biodegradable. To remediate VOCs, the hydrogels can be formed into small beads suitable for packing into filtration columns and modified to be partially amphiphilic, to enhance the absorption and diffusion of non-polar hydrocarbons. The hydrogel design can be guided by molecular dynamics (MD) simulations and machine learning (ML), as described herein. The outer surface of the beads can be modified to increase mechanical strength, reduce water loss, and prevent biofouling.

The inclusion of hydrophobic units in amphiphilic hydrogels can improve the mechanical properties, adhesion, and encapsulation of non-polar drugs in self-assembled hydrophobic blocks or micelles. The hydrophobic units may either be physically incorporated or covalently grafted to the alginate. One approach for amphiphilic modification of a hydrogel is combining with a surfactant such as sodium dodecyl sulfate (SDS) or Brij® 35. A non-ionic surfactant appears to soften the hydrogel, whereas an anionic surfactant such as SDS appears to stiffen it, due at least in part to increased electrostatic repulsion.

In some implementations, the alginate can be modified with polymer brushes via photoinduced electron transfer-reversible addition-fragmentation chain transfer (PET-RAFT) polymerization to enlarge the molecular scale hydrophobic pockets (e.g., in SDS). PET-RAFT provides a green and atom-economical strategy for controlled radical polymerization. The alginate grafted with hydrophobic polymethacrylate (PMA) brushes, upon hydrogel formation, should self-assemble PMA blocks of sizes commensurate with the length of the brush. The hydrophobic brush will also passivate the air surface of the hydrogel to reduce surface energy; a hydrophobic passivating layer at the surface can improve water retention and facilitate VOC diffusion.

Molecular modeling, including the use of density functional theory (DFT), molecular dynamics (MD) simulations, and machine learning (ML), can be used to inform the engineering of the biochar and the hydrogel systems. Specifically, DFT can be used to study the electronic properties that influence the VOC adsorption of biochar, with a focus on the presence of iron and phenolic groups. Algae-derived biochar contains specific types and concentrations of phenolic compounds, which play a role in VOC adsorption. MD can be used to investigate the diffusion behavior of VOC compounds within the hydrogel matrix. These simulations will enable analysis of VOC interactions at the molecular level, providing insights into how the hydrogel's pore structure, water content, and chemical properties influence the transport and retention of VOC molecules.

DFT results confirm that phenolic compounds, especially those with electron-donating groups such as —CH₃ and —OCH₃, strongly interact with VOCs via hydrogen bonding and other non-covalent interactions. This suggests that certain biochars, particularly those rich in phenolic groups, are better suited for enhancing VOC adsorption. DFT modeling results also show that not only do phenolic compounds have the ability to adsorb VOCs, they also influence the performance and effectiveness of metal sites in biochar during VOC adsorption. Specifically, DFT-based molecular modeling reveals that the presence of phenolic OH groups enhance the interaction between metal sites on biochar and VOCs such as dibenzothiophene. The phenolic groups facilitate stronger interactions between the metal sites and the VOC molecules, which improves the overall adsorption capacity of the biochar. This highlights the role of phenolic compounds in adsorbing VOCs and increasing the performance of metal sites in biochar. This understanding can be used in combination with ML to develop algal biochar containing iron and phenolics with enhanced capabilities for VOC removal.

In addition, the presence of phenolic groups on biochar can facilitate its encapsulation in sodium alginate hydrogel through interactions between the phenolic groups and alginate matrices. The hydroxyl (—OH) groups in phenolic compounds can form hydrogen bonds with the carboxyl (—COOH) groups in sodium alginate, enhancing the compatibility between biochar and the hydrogel. This bonding promotes stable encapsulation, improving the integration of biochar into the alginate matrix. Understanding the structure-activity relationship of phenolic compounds and the mechanisms by which they contribute to biochar's role in VOC adsorption and encapsulation helps guide engineering of the biochar.

ML can be used, for example, to develop surrogate models predicting the efficacy of a phenol-rich bio-oil to interact with sulfur, and to carry out surrogate-based optimization (active learning) for tuning the biochar processing procedure to obtain iron-rich biochar containing phenolics. Surrogates (metamodels or ML models in the present context) are regression tools for mapping the input space to the output space using low-fidelity models.

Evaluating the efficacy of phenol-decorated iron-rich biochar at adsorbing VOC can involve expensive experiments or performing computationally demanding quantum chemistry calculations or MD simulations. A properly trained surrogate can make useful predictions about the efficacy and properties of candidate phenolics at a substantially lower computational cost.

The hydrogel can be characterized in terms of its water absorption or water loss, its mechanical strength (e.g., elastic modulus and loss modulus), and its resistance to biofouling. The efficacy of hydrogel to adsorb and degrade select VOCs can be further evaluated, for example, by infrared spectroscopy (Raman and FTIR) to detect VOC absorption and monitor the chemical composition of the hydrogel. Raman spectroscopy can examine the depth of the hydrogel and detect signatures of absorbed VOCs and their degradation products in the hydrogel. Raman spectroscopy can also be used to monitor the evolution of the chemical environment within the hydrogel for any evidence of degradation of the gel itself or for signs of growth or stress of the inoculating colonies.

FTIR measurements can be performed, for example, with an instrument that is equipped with a GladiATR™ Illuminate attenuated total reflectance (ATR) accessory (Pike Technologies). This accessory enables application of heat up to 210° C. or UV exposure via a high-power 365 nm LED light source during FTIR measurement. This instrument can be used to characterize the chemical composition of the hydrogel surface before and after VOC absorption and to examine the hydrogel's resilience under UV irradiation. The biochar is expected to provide sufficient protection to the inoculated colonies within the hydrogel such that UV irradiation could be used to disinfect the hydrogel surface in the event of external biofouling. To establish the benchmark, spectra of clean hydrogel are obtained, followed by VOC adsorption, which includes circulating a VOC composition through filtration columns packed with hydrogel beads. Hydrogel recovered from this process will be analyzed by FTIR and Raman spectroscopy.

Gas chromatography-mass spectrometry (GC-MS) can also be used to validate the findings obtained from infrared spectroscopy. Following VOC exposure, the hydrogel beads can be immersed in either an aqueous solution or dimethyl sulfoxide (DMSO), to leach out the absorbed compounds while preserving the integrity of the microbiome and preventing the dissolution of the gel. The resulting leachate solution can be analyzed using GC-MS to identify the released compounds, including any VOCs and their degradation products.

Optical profilometry and atomic force microscopy (AFM) can be used to evaluate the surface morphology and potential biofouling of the hydrogel. For transparent hydrogels, optical profilometry is able to estimate the thickness of the hydrogel coating around the biochar particles in addition to imaging its surface topology with lateral resolution up to 300 nm. In AFM, a decrease in stiffness of bacteria or an increase in adhesion energy between the AFM tip and bacteria can be inferred to be signs of membrane disruption in addition to any superficial changes in surface morphology that may be visible in the microscope images. AFM, profilometry, and FTIR can be used to examine changes in a hydrogel before and after VOC filtration.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An adsorbent comprising:
a hydrogel comprising polysaccharide;
bacteria in the hydrogel; and
biochar, graphite, or both in the hydrogel,
wherein the adsorbent is regenerative.

2. The adsorbent of claim 1, wherein the polysaccharide comprises alginate, chitosan, or a combination thereof.

3. The adsorbent of claim 2, wherein the polysaccharide comprises alginate treated with a metal salt.

4. The adsorbent of claim 2, wherein the polysaccharide comprises chitosan.

5. The adsorbent claim 1, wherein the biochar, the graphite, or both comprise one or more of iron, copper, phosphorus, sulfur, an oxide thereof, or any combination thereof.

6. The adsorbent of claim 1, wherein the bacteria comprise one or more microbes that metabolize volatile organic compounds (VOCs).

7. The adsorbent of claim 6, wherein the bacteria comprise Pseudomonas, Rhodococcus, Enterobacter sp., or any combination thereof.

8. The adsorbent of claim 6, wherein the bacteria further comprise one or more sulfur-oxidizing microbes.

9. The adsorbent of claim 1, wherein the one or more sulfur-oxidizing microbes comprise Gordonia, Nocardia, or a combination thereof.

10. The adsorbent of claim 1, wherein the hydrogel is amphiphilic.

11. The adsorbent of claim 1, wherein the adsorbent is in the form of a bead.

12. The adsorbent of claim 1, wherein the adsorbent further comprises a surfactant.

13. The adsorbent of claim 1, wherein the adsorbent further comprises cyclodextrin (CD).

14. The adsorbent of claim 1, wherein the adsorbent further comprises a quaternary ammonium compound.

15. The adsorbent of claim 1, wherein the adsorbent further comprises a vinyl monomer under photoinduced electron transfer-reversible addition-fragmentation chain transfer (PET-RAFT) polymerization.

16. A method of removing VOCs from the air within a building, the method comprising contacting the air within the building with the adsorbent of claim 1.

17. The method of claim 16, wherein the adsorbent is incorporated within one or more construction materials of the building.

18. The method of claim 16, wherein the adsorbent is incorporated within an air handling system of the building.

19. The method of claim 16, wherein the adsorbent is incorporated within one or more mobile units configured to be in fluid communication with an interior of the building.

20. The method of claim 16, wherein the VOCs comprise polycyclic aromatic hydrocarbons (PAHs).
